(19) United States
(12) Patent Application Publication
(10) Pub. No.: US 2014/0295160 A1
(43) Pub. Date: Oct. 2, 2014

(54) MULTI-LAYER BODIES MADE OF POLYCARBONATE WITH A DEEP GLOSS EFFECT

(71) Applicant: Bayer Intellectual Property GmbH, Monheim (DE)

(72) Inventors: Alexander Meyer, Dusseldorf (DE); Peter Capellen, Krefeld (DE); Jörg Reichenauer, Krefeld (DE); Reiner Rudolf, Langenfeld (DE); Andreas Seidel, Dormagen (DE); Hans-Jürgen Thiem, Dormagen (DE)

(21) Appl. No.: 14/359,509

(22) PCT Filed: Nov. 27, 2012
(86) PCT No.: PCT/EP2012/073713

§ 371 Date: May 20, 2014

(30) Foreign Application Priority Data
Nov. 30, 2011 (EP) 11191312.5

(51) Int. Cl. C08K 3/04

(52) U.S. Cl. CPC C08K 3/04
USPC 428/216; 428/336; 428/323; 427/322

(57) ABSTRACT

Multi-layer bodies comprising: 1) a base layer comprising at least one thermoplastic; nanoscale carbon black in an amount of from 0.05 to 0.15 wt. %; a demoulding agent based on a fatty acid ester in a concentration of from 0.1 to 0.5 wt. %, 2) at least on one side of the base layer a scratch-resistant coating based on polysiloxane having a thickness of from 2 to 15 μm, comprising at least one UV absorber, wherein the sum of the values of the above-mentioned components of the base layer is 100 wt. %.

The present invention relates to dark multi-layer bodies made of polycarbonate which are distinguished by a glass-like deep-gloss effect on the surface. The invention relates also to a process for the production of such multi-layer bodies.

The multi-layer bodies are preferably composed of polycarbonate or polycarbonate blends. The polycarbonate blends can comprise further polymers, such as, for example, elastomers or graft polymers or further thermoplastics, such as, for example, polyesters.

The invention relates further to the use of the multi-layer bodies according to the invention as surrounds for automotive exterior parts or as frame parts for multi-media casings.

Dark multi-layer bodies made of polycarbonate are known per se.

Nevertheless, there has hitherto been a lack of multi-layer systems made of polycarbonate or polycarbonate blends which are distinguished by a glass-like deep-gloss effect. The multi-layer systems are not transparent bodies but dark multi-layer plastics mouldings which have a glass-like surface with a deep-gloss appearance. Such multi-layer bodies are suitable in particular for automotive exterior parts. They must have an excellent surface quality, a deep-gloss effect, and excellent stability to weathering. Possible applications include inter alia frame parts for glazing made of glass, such as, for example, sunroofs. Because of the long service life of motor vehicles, it is important in particular in the field of high-priced cars that the desired high-quality colour impression—here the particularly black deep-gloss effect—of the material is retained without appreciable losses over the period of the useful life.

Such multi-layer bodies offer many advantages over conventional materials such as, for example, glass for use in the automotive sector. These include, for example, increased fracture resistance and/or weight saving, which in the case of cars permit higher occupant safety in the event of road traffic accidents, and lower fuel consumption. Finally, materials that comprise thermoplastic polymers permit substantially greater freedom in terms of design because they are easier to mould.

Automotive exterior parts which are used in the motor vehicle, railway vehicle and aircraft sector and in the infrastructure sector must additionally have a long service life and must not become brittle during that time. Moreover, the colour and gloss effect should not change or should change only slightly over the service life. Furthermore, the thermoplastic parts must have sufficient scratch resistance.

Because of the long service life that is required and because of the high surface quality and the deep-gloss effect, glass is frequently used as a material. Glass is insensitive to UV radiation, has low sensitivity to scratching and does not change in terms of its mechanical properties over long periods. Because inorganic oxides, such as, for example, iron oxide, are used as pigments, the colour properties also remain virtually unchanged over long periods. The use of such pigments in thermoplastic materials is not possible, however, because it leads to degradation of the corresponding matrix.

Because of the above-described advantages of plastics, there is therefore a need for materials which exhibit both the good physical properties of thermoplastics and the high surface quality and the desired deep-gloss effect of correspondingly black-coloured glasses.

Among the transparent thermoplastic plastics, polymers based on polycarbonate and polymethyl methacrylate (PMMA), for example, are particularly suitable for use as exterior parts for automotive applications. On account of its high toughness, polycarbonate in particular has a very good property profile for such uses.

In order to improve the service life of thermoplastic materials, it is known to provide them with UV protection and/or scratch-resistant coatings. Moreover, a large number of colouring agents that have high light fastness are known.

It has been shown, however, that the thermoplastic compositions mentioned in the prior art are only inadequately suitable when extraordinarily high stability to weathering is required with a high surface quality and a high deep-gloss effect. The prior art does not offer any possible solutions in particular for deep-black components having a piano-lacquer-like surface for exterior applications.

In the prior art, black or dark exterior parts are frequently coloured with carbon black in order to obtain the desired black impression. The use of carbon black is problematical, however, because it can lead to surface defects. Carbon black in nanoscale form should not actually affect the surface because of the small particle size, but agglomerates form very easily and then lead to surface faults again. These surface faults are noticeable with the naked eye. Furthermore, these surface faults constitute defect sites for subsequent coating, so that the lacquer has a tendency to delamination, crack formation, etc. at that site when subjected to weathering. A high surface quality with as few defect sites as possible is therefore highly advantageous for both optical and technical reasons. Attempts are frequently also made to introduce the carbon black into the thermoplastic matrix in the form of a dispersion. However, the dispersing agents are frequently functionalised in order to keep the inorganic particles in dispersion. The functional groups damage the thermoplastic matrix, in particular the polycarbonate matrix, however, and are therefore undesirable.

When carbon black is used as the colouring agent, the injection-moulded articles frequently do not have a deep-gloss effect but appear dull and in some cases slightly yellowish owing to the absorption spectrum of carbon. With very low concentrations of carbon black, on the other hand, the deep black impression is lost.

A high-gloss surface can also be achieved by means of nanoscale or finely divided carbon modifications such as, for example, carbon nanotubes, as described in WO 2009030357, or graphite, as disclosed in JP 2003073557. However, the rod-like or plate-like form of the particles confers upon the injection-moulded body a certain surface roughness, which is undesirable.

In order to avoid the above-described disadvantages associated with carbon black or other carbon modifications, soluble dyes are frequently used in order to achieve a high surface gloss—a kind of piano-lacquer appearance. However, this solution has the disadvantage that the dyes must be used in a relatively high concentration in order to achieve an adequate black impression. This is associated with significantly higher costs as compared with carbon black. Furthermore, organic dyes frequently fade under the effect of UV radiation, so that the colour impression changes over time. Certain colour settings for automotive exterior parts which also use dyes are described, for example, in JP 11106518.

The object was, therefore, to develop from a thermoplastic material—preferably from polycarbonate—a black finished part having a light transmission of less than 0.1% which combines low costs with an excellent surface quality, high deep gloss, a piano-lacquer-like black impression and high weathering resistance and which is suitable for frame parts in the automotive sector or for multi-media casings, such as, for example, television frames or the like, which are exposed to UV radiation.

In particular, U-shaped, O-shaped or rectangular black surrounds which are suitable for exterior applications in the automotive sector are to be developed. These surrounds are distinguished in that they enclose or frame glass elements such as windows or sunroofs. As a result of the black deep-gloss appearance, the window region appears enlarged because the roof, such as, for example, a panoramic roof, has a solid-glass appearance. Decorative surrounds are also included. Intermediate members which optically join glass units are also meant, as are intermediate members between the A-pillar and the B-pillar. Reinforcing ribs, mounting aids and regions for receiving the adhesive bead are optionally injection moulded onto the frame in order to permit corresponding easy mounting. Special shaping, such as a special 3-dimensional shape, can further be present. Because the frames are relatively large and have a complex geometry, the thermoplastic material must have sufficient flowability to be able to be processed into corresponding moulded bodies by the injection moulding process, such as, for example, specifically the injection-compression moulding process.

A further object of the present invention was to provide a process for the production of thermoplastic multi-layer bodies having the properties described above.

Surprisingly, it has been possible to achieve the object by means of specific multi-layer plastics mouldings which have an extremely low surface defect rate and a UV- and scratch-resistant coating. Expensive colouring agents and functional dispersing agents are not used. It was surprising that only very specific concentrations of a specific black pigment in combination with a transparent lacquer layer are suitable for achieving the desired deep-gloss effect. The multi-layer body must further exhibit only a very low defect rate on the surface.

It has accordingly been possible to achieve the object by means of a thermoplastic polymer composition according to the invention prepared using a process according to the invention, and a UV- and scratch-resistant coating.

The multi-layer body according to the invention comprises:

1) A base layer comprising
at least one thermoplastic, preferably polycarbonate or a polycarbonate blend, more preferably having a melt volume-flow rate of
   i. from 7 cm³/(10 min) to 25 cm³/(10 min),
   ii. preferably from 9 to 21 cm³/(10 min),
      according to ISO 1133 (at 300° C. and 1.2 kg load),
nanoscale carbon black in an amount of
   i. from 0.05 to 0.15 wt. %,
   ii. preferably from 0.06 to 0.12 wt. %,
and at least one demoulding agent based on a fatty acid ester,
   i. preferably a stearic acid ester,
   ii. particularly preferably based on pentaerythritol,
      in a concentration of
   iii. from 0.1 to 0.5 wt. %,
   iv. particularly preferably from 0.20 to 0.45 wt. %,
wherein an injection-moulded body produced from this composition has a surface defect rate of less than 10, preferably less than 6, surface defects per cm².

Preferably, the base layer comprises a heat stabiliser.

Particularly preferably, the thermoplastic plastic of the base layer is polycarbonate.

2) At least on one side of the base layer
a scratch-resistant coating based on polysiloxane, comprising
   i. at least one UV absorber,
      wherein
   ii. the thickness of the scratch-resistant layer is from 2 to 15 μm, particularly preferably from 4.0 to 12.0 μm.

3) Optionally, in a particular embodiment, at least one adhesion-promoting layer (primer layer) arranged on the base layer between the base layer and the scratch-resistant layer, comprising
i. at least one UV absorber,
   wherein
ii. the thickness of the primer layer is from 0.3 to 8 μm, particularly preferably from 1.1 to 4.0 μm.

In a further preferred embodiment, an adhesion-promoting layer and a scratch-resistant layer are applied to both sides of the base layer.

In a preferred embodiment, the sum of the values of the above-mentioned components of the base layer is 100 wt. %.

The deep appearance is achieved by the combination according to the invention of a specific thermoplastic composition comprising specific amounts of nanoscale carbon black in a combination with specific demoulding agents, whereby a corresponding injection-moulded body has a high surface quality (low defect rate), with a primer layer of a specific thickness and a scratch-resistant layer of polysiloxane lacquer. Only the combination of these components and properties allows such an effect to be achieved.

The thermoplastic component of the base layer a) comprises:

a thermoplastic, preferably transparent, thermoplastic plastic, preferably polycarbonate, copolycarbonate, polyester carbonate, polystyrene, styrene copolymers, aromatic polyesters such as polyethylene terephthalate (PET), PET-cyclohexanedimethanol copolymer (PETG), polyethylene naphthalate (PEN), polybutylene terephthalate (PBT), cyclic polyolefin, poly- or poly- or copoly-acrylates and poly- or copoly-methacrylate such as, for example, poly- or copoly-methyl methacrylates (such as PMMA) as well as copolymers with styrene such as, for example, transparent polystyrene acrylonitrile (PSAN), thermoplastic polyurethanes, polymers based on cyclic olefins (e.g. TOPAS®, a commercial product of Ticona), more preferably polycarbonate, copolycarbonate, polyester carbonate, aromatic polyesters or polymethyl methacrylate, or mixtures of the mentioned components, and particularly preferably polycarbonate and copolycarbonate, the transparent thermoplastic plastic being added in an amount that gives 100 wt. % with all the other components.

Mixtures of a plurality of transparent thermoplastic polymers are also possible, in particular when they can be mixed together to give a transparent mixture, preference being given in a specific embodiment to a mixture of polycarbonate with PMMA (more preferably with PMMA<2 wt. %) or polyester.

Suitable polycarbonates for the preparation of the plastics composition according to the invention are all known polycarbonates. They are homopolycarbonates, copolycarbonates and thermoplastic polyester carbonates.

Rubber-modified vinyl (co)polymers and/or further elastomers are also suitable as blend partners.

The polycarbonates that are suitable preferably have mean molecular weights M̅_{w} of from 10,000 to 50,000, preferably from 14,000 to 40,000 and in particular from 16,000 to 32,000, determined by gel permeation chromatography with polycarbonate calibration. The preparation of the polycarbonates is preferably carried out by the interfacial process or the melt transesterification process, which are described variously in the literature.

With regard to the interfacial process, reference is made by way of example to H. Schnell, “Chemistry and Physics of Polycarbonates”, Polymer Reviews, Vol. 9, Interscience Publishers, New York 1964 p. 33 ff, to Polymer Reviews, Vol. 10, “Condensation Polymers by Interfacial and Solution Methods”, Paul W. Morgan, Interscience Publishers, New York 1965, Chap. VIII, p. 325, to Dres. U. Grigo, K. Kircher and P. R- Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, p. 118-145 as well as to EP 0 517 044 A1.

The melt transesterification process is described, for example, in Encyclopedia of Polymer Science, Vol. 10 (1969), Chemistry and Physics of Polycarbonates, Polymer Reviews, H. Schnell, Vol. 9, John Wiley and Sons, Inc. (1964) as well as in the patent specifications DE-B 10 31 512 and U.S. Pat. No. 6,228,973.

The polycarbonates are prepared preferably by reactions of bisphenol compounds with carbonic acid compounds, in particular phosgene, or, in the case of the melt transesterification process, diphenyl carbonate or dimethyl carbonate.

Particular preference is given to homopolycarbonates based on bisphenol A and copolycarbonates based on the monomers bisphenol A and 1,1-bis-(4-hydroxyphenyl)-3,3,5-trimethylcyclohexane.

These and further bisphenol and diol compounds which can be used for the polycarbonate synthesis are disclosed inter alia in WO 2008037364 A1 (p. 7, 1. 21 to p. 10, 1. 5), EP 1 582 549 A1 ([0018] to [0034]), WO 2002026862 A1 (p. 2, 1. 20 to p. 5, 1. 14), WO 2005113639 A1 (p. 2, 1. 1 to p. 7, 1. 20).

The polycarbonates can be linear or branched. Mixtures of branched and unbranched polycarbonates can also be used.

Suitable branching agents for polycarbonates are known from the literature and are described, for example, in patent specifications U.S. Pat. No. 4,185,009 and DE 25 00 092 A1 (3,3-bis-(4-hydroxyaryl-oxindoles according to the invention, see the whole document in each case), DE 42 40 313 A1 (see p. 3, 1. 33 to 55), DE 19 943 642 A1 (see p. 5, 1. 25 to 34) and U.S. Pat. No. 5,367,044 as well as in literature cited therein.

Moreover, the polycarbonates that are used can also be intrinsically branched, in which case no branching agent is added within the context of the polycarbonate preparation. An example of intrinsic branching are so-called Fries structures, as are disclosed in EP 1 506 249 A1 for melt polycarbonates.

Chain terminators can additionally be used in the polycarbonate preparation. There are used as chain terminators preferably phenols such as phenol, alkylphenols such as cresol and 4-tert-butylphenol, chlorophenol, bromophenol, cumylphenol or mixtures thereof.

The base layer 1) comprises demoulding agents based on a fatty acid ester, preferably a stearic acid ester, particularly preferably based on pentaerythritol.

In a particular embodiment, pentaerythritol tetrastearate (PETS) and/or glycerol monostearate (GMS) is used.

The base layer 1) further comprises a nanoscale carbon black.

Carbon black according to the present invention is a black pulverulent solid which, depending on the quality and use, consists substantially of carbon. The carbon content of carbon black is generally from 80.0 to 99.9 wt. %. In carbon blacks that have not been subjected to oxidative after-treatment, the carbon content is preferably from 96.0 to 95.5 wt. %. By extraction of the carbon black with organic solvents, for example with toluene, traces of organic impurities on the carbon black can be removed and the carbon content can thereby be increased to even greater than 99.9 wt. %. In carbon blacks that have been subjected to oxidative after-treatment, the oxygen content can be up to 30 wt. %, preferably up to 20 wt. %, in particular from 5 to 15 wt. %.

Carbon black consists of mostly spherical primary particles having a size of preferably from 10 to 500 nm. These primary particles have grown together to form chain-like or branched aggregates. The aggregates are generally the smallest unit into which the carbon black can be broken in a dispersing process. Many of these aggregates combine again by intermolecular (van der Waals) forces to form agglomerates. Both the size of the primary particles and the aggregation (structure) thereof can purposively be adjusted by varying the preparation conditions. The term structure is understood by the person skilled in the art as meaning the nature of the three-dimensional arrangement of the primary particles in an aggregate. The term “high structure” is used for carbon blacks having highly branched and crosslinked aggregate structures; “low structure”, on the other hand, refers to largely linear aggregate structures, that is to say those with little branching and crosslinking.

The oil adsorption number, measured according to ISO 4656 with dibutyl phthalate (DBP), is generally given as a measure of the structure of a carbon black. A high oil adsorption number is indicative of a high structure.

The primary particle size of a carbon black can be determined, for example, by means of scanning electron microscopy. However, the BET surface area of a carbon black, determined according to ISO 4652 with nitrogen adsorption, is also used as a measure of the primary particle size of a carbon black. A high BET surface area is indicative of a small primary particle size.

The dispersibility of the agglomerates of a carbon black depends on the primary particle size and on the structure of the aggregates, the dispersibility of the carbon black generally decreasing as the primary particle size and the structure decrease.

As an industrial product, industrial carbon black is produced by incomplete combustion or pyrolysis of hydrocarbons. Processes for producing industrial carbon black are known in the literature. Known processes for producing industrial carbon blacks are in particular the furnace, gas black, flame black, acetylene black and thermal black processes.

The particle size distribution of the primary particles, as well as the size and structure of the primary particle aggregates, determine properties such as colour depth, base tone and conductivity of the carbon black. Conductive blacks generally have small primary particles and widely branched aggregates. Colour carbon blacks are generally carbon blacks having very small primary particles and are often subjected to subsequent oxidation after they have been produced by one of the above-mentioned processes. The oxidic groups thereby attached to the carbon black surface are to increase the compatibility with the resins in which the colour carbon blacks are to be introduced and dispersed.

Colour carbon blacks are preferably used. In a preferred embodiment, they have a mean primary particle size, determined by scanning electron microscopy, of less than 100 nm, preferably from 10 to 99 nm, more preferably from 10 to 50 nm, particularly preferably from 10 to 30 nm, in particular from 10 to 20 nm. The particularly finely divided colour carbon blacks are therefore particularly preferred in the process according to the invention because the achievable colour depth and UV resistance with a specific amount of carbon black increases as the primary particle size falls; on the other hand, however, their dispersibility also falls, which is why such very finely divided carbon blacks in particular are in need of improvement in respect of dispersibility.

The colour carbon blacks which are preferably used have a BET surface area, determined according to ISO 4652 by nitrogen adsorption, of preferably at least 20 m²/g, more preferably at least 50 m²/g, particularly preferably at least 100 m²/g, in particular at least 150 m²/g.

Colour carbon blacks which are preferably used are additionally characterised by an oil adsorption number, measured according to ISO 4656 with dibutyl phthalate (DBP), of preferably from 10 to 200 ml/100 g, more preferably from 30 to 150 ml/100 g, particularly preferably from 40 to 120 ml/100 g, in particular from 40 to 80 ml/100 g. The colour carbon blacks having a low oil adsorption number generally achieve a better colour depth and are preferred in that respect but, on the other hand, they are generally more difficult to disperse, which is why such carbon blacks in particular are in need of improvement in respect of dispersibility.

The carbon blacks which are used can be and are preferably used in pelletised or pearl form. Pearling or pelletisation is carried out by processes known in the literature and on the one hand is used to increase the bulk density and improve the metering (flow) properties, but on the other hand is also carried out for reasons of hygiene in the workplace. The hardness of the pellets or pearls is preferably so adjusted that they withstand transportation and feeding processes during metering largely undamaged, but break up completely into agglomerates again when subjected to greater mechanical shear forces as are encountered, for example, in commercial powder mixing devices and/or compounding units.

Carbon blacks which are obtainable commercially and are suitable within the scope of the invention are obtainable under a large number of trade names and in a large number of forms, such as pellets or powders. For example, suitable carbon blacks are obtainable under the trade name BLACK PEARLS®, in the form of wet-processed pellets under the names ELFTEX®, REGAL® and CSX®, and in a flocculent form under the names MONARCH®, ELFTEX®, REGAL® and MOGUL®—all obtainable from Cabot Corporation.

Particular preference is given to carbon blacks which are marketed under the trade name BLACK PEARLS® (CAS No. 1333-86-4).

In a preferred embodiment, the polymer composition of the base layer further comprises at least one heat or processing stabiliser.

There are preferably suitable phosphites and phosphonites as well as phosphines. Examples are triphenyl phosphite, diphenylalkyl phosphite, phenyldialkyl phosphite, tris(nonylphenyl)phosphite, trilauryl phosphite, trioctadecyl phosphite, distearylpentaerythritol diphosphite, tris(2,4-di-tert-butylphenyl)phosphite, diisodecylpentaerythritol diphosphite, bis(2,4-di-tert-butylphenyl)-pentaerythritol diphosphite, bis(2,4-dicumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)-pentaerythritol diphosphite, bis(2,4,6-tris(tert-butylphenyl)-pentaerythritol diphosphite, tristearylsorbitol triphosphite, tetrakis(2,4-di-tert-butylphenyl)-4,4′-biphenylene diphosphonite, 6-isooctyloxy-2,4, 8,10-tetra-tert-butyl-12H-dibenz[d,g]-1,3,2-dioxaphosphocine, bis(2,4-di-tert-butyl-6-methylphenyl)methyl phosphite, bis(2,4-di-tert-butyl-6-methylphenyl)ethyl phosphite, 6-fluoro-2,4,8,10-tetra-tert-butyl-12-methyl-dibenz[d,g]-1,3,2-dioxaphosphocine, 2,2′,2″-nitrilo-[triethyltris(3,3′,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl)phosphite, 5-butyl-5-ethyl-2-(2,4,6-tri-tert-butylphenoxy)-1,3,2-dioxaphosphirane, bis(2,6-di-tert-butyl-4-methyl-phenyl)pentaerythritol diphosphite, triphenylphosphine (TPP), trialkylphenylphosphine, bisdiphenylphosphino-ethane or a trinaphthylphosphine. Particular preference is given to the use of triphenylphosphine (TPP), Irgafos® 168 (tris(2,4-di-tert-butyl-phenyl)phosphite) and tris(nonylphenyl)phosphite or mixtures thereof.

Phenolic antioxidants such as alkylated monophenols, alkylated thioalkylphenols, hydroquinones and alkylated hydroquinones can further be used. Particular preference is given to the use of Irganox® 1010 (pentaerythritol 3-(4-hydroxy-3,5-di-tert-butylphenyl)propionate; CAS: 6683-19-8) and Irganox 1076® (2,6-di-tert-butyl-4-(octadecanoxycarbonylethyl)phenol).

In a specific embodiment of the present invention, the phosphine compounds according to the invention are used together with a phosphite or a phenolic antioxidant or a mixture of the two last-mentioned compounds.

The heat and processing stabilisers are used in amounts of from 0.00 wt. % to 0.20 wt. %, preferably from 0.01 wt. % to 0.10 wt. %, more preferably from 0.01 wt. % to 0.05 wt. % and particularly preferably from 0.015 wt. % to 0.040 wt. %.

Optionally, the base layer according to the invention further comprises an ultraviolet absorber. Ultraviolet absorbers suitable for use in the polymer composition according to the invention are compounds that have as low a transmission as possible below 400 nm and as high a transmission as possible above 400 nm. Such compounds and the preparation thereof are known in the literature and are described, for example, in EP-A 0 839 623, WO-A 96/15102 and EP-A 0 500 496. Particularly suitable ultraviolet absorbers for use in the composition according to the invention are benzotriazoles, triazines, benzophenones and/or arylated cyanoacrylates.

In a particularly preferred embodiment, the base layer does not comprise UV absorber.

If UV absorbers are to be used in the base layer, the following ultraviolet absorbers are suitable, such as, for example, hydroxybenzotriazoles, such as, 2-(3′,5′-bis-(1,1-dimethylbenzyl)-2′-hydroxy-phenyl)-benzotriazole (Tinuvin® 234, Ciba Spezialitatenchemie, Basel), 2-(2′-hydroxy-5′-(tert-octyl)-phenyl)-benzotriazole (Tinuvin® 329, Ciba Spezialitatenchemie, Basel), 2-(2′-hydroxy-3′-(2-butyl)-5′-(tert-butyl)-phenyl)-benzotriazole (Tinuvin® 350, Ciba Spezialitatenchemie, Basel), bis-(3-(2H-benztriazolyl)-2-hydroxy-5-tert-octyl)methane (Tinuvin® 360, Ciba Spezialitatenchemie, Basel), (2-(4,6-diphenyl-1,3,5-triazin-2-yl)-5-(hexyloxy)-phenol (Tinuvin® 1577, Ciba Spezialitätenchemie, Basel), as well as the benzophenones 2,4-dihydroxy-benzophenone (Chimasorb® 22, Ciba Spezialitatenchemie, Basel) and 2-hydroxy-4-(octyloxy)-benzophenone (Chimassorb® 81, Ciba, Basel), 2-propenoic acid, 2-cyano-3,3-diphenyl-2,2-bis[[(2-cyano-1-oxo-3,3-diphenyl-2-propenyl)oxy]-methyl]-1,3-propanediyl ester (9CI) (Uvinul® 3030, BASF AG Ludwigshafen), 2-[2-hydroxy-4-(2-ethylhexyl)oxy]phenyl-4,6-di(4-phenyl)phenyl-1,3,5-triazine (CGX UVA 006, Ciba Spezialitatenchemie, Basel) or tetra-ethyl-2,2′-(1,4-phenylene-dimethylidene)-bismalonate (Hostavin® B-Cap, Clariant AG).

Mixtures of these ultraviolet absorbers can also be used.

The UV absorbers are preferably used in an amount of from 0.0 wt. % to 20.0 wt. %, preferably from 0.05 wt. % to 10.00 wt. %, more preferably from 0.10 wt. % to 1.00 wt. %, yet more preferably from 0.10 wt. % to 0.50 wt. %, as well as most particularly preferably from 0.10 wt. % to 0.30 wt. %.

Optionally, the base layer comprises from 0.0 wt. % to 5.0 wt. %, preferably from 0.01 wt. % to 1.00 wt. %, of at least one further additive. The further additives are conventional polymer additives, such as, for example, those described in EP-A 0 839 623, WO-A 96/15102, EP-A 0 500 496 or “Plastics Additives Handbook”, Hans Zweifel, 5th Edition 2000, Hamer Verlag, Munich, such as, for example, flame retardants, antistatics or flow improvers. The components of the base layer that have already been mentioned are expressly excluded in this context.

The amounts stated above relate in each case to the polymer composition as a whole. In an alternative embodiment, the base layer consists only of the components mentioned above.

Rubber-modified vinyl (co)polymers can further be used as blend partners.

Preferred rubber-modified vinyl (co)polymers comprise one or more graft polymers of
from 5 to 95 wt. %, preferably from 20 to 90 wt. %, in particular from 25 to 50 wt. %, based on the rubber-modified vinyl (co)polymer, of at least one vinyl monomer on
from 95 to 5 wt. %, preferably from 80 to 10 wt. %, in particular from 75 to 50 wt. %, based on the rubber-modified vinyl (co)polymer, of one or more graft bases.

The graft base generally has a mean particle size (d₅₀ value) of from 0.05 to 10 μm, preferably from 0.1 to 2 μm, particularly preferably from 0.15 to 0.6 μm.

Vinyl monomers are preferably mixtures of
from 50 to 99 parts by weight, preferably from 60 to 80 parts by weight, in particular from 70 to 80 parts by weight, of vinyl aromatic compounds and/or vinyl aromatic compounds substituted on the ring (such as styrene, α-methylstyrene, p-methylstyrene, p-chlorostyrene) and/or methacrylic acid (C₁-C₈)-alkyl esters, such as methyl methacrylate, ethyl methacrylate, and
from 1 to 50 parts by weight, preferably from 20 to 40 parts by weight, in particular from 20 to 30 parts by weight, of vinyl cyanides (unsaturated nitriles such as acrylonitrile and methacrylonitrile) and/or (meth)acrylic acid (C₁-C₈)-alkyl esters, such as methyl methacrylate, n-butyl acrylate, tert-butyl acrylate, and/or derivatives (such as anhydrides and imides) of unsaturated carboxylic acids, for example maleic anhydride and N-phenyl-maleimide.

Preferred vinyl monomers are mixtures comprising at least one monomer selected from the group consisting of styrene, α-methylstyrene and methyl methacrylate and at least one further monomer selected from the second group consisting of acrylonitrile, maleic anhydride and methyl methacrylate. Particularly preferred vinyl monomers are mixtures of styrene and acrylonitrile.

Graft bases suitable for the graft polymers are, for example, diene rubbers, EP(D)M rubbers, that is to say those based on ethylene/propylene and optionally diene, acrylate, polyurethane, silicone, chloroprene and ethylene/vinyl acetate rubbers, as well as silicone/acrylate composite rubbers.

Preferred graft bases are diene rubbers, for example based on butadiene and isoprene, or mixtures of diene rubbers or copolymers of diene rubbers or mixtures thereof with further copolymerisable monomers (e.g. vinyl monomers according to the above definition).

The glass transition temperature of the graft bases is preferably <10° C., more preferably <0° C., particularly preferably <−20° C.

The glass transition temperatures are determined by means of differential scanning calorimetry (DSC) according to standard DIN EN 61006 at a heating rate of 10 K/min with definition of the Tg as the mid-point temperature (tangent method).

Pure polybutadiene rubber is particularly preferred.

Particularly preferred rubber-modified vinyl (co)polymers are, for example, ABS polymers (emulsion, mass and suspension ABS), as are described, for example, in DE-OS 2 035 390 (=U.S. Pat. No. 3,644,574) or in DE-OS 2 248 242 (=GB-PS 1 409 275) or in Ullmanns, Enzyklopädie der Technischen Chemie, Vol. 19 (1980), p. 280 ff.

The rubber-modified vinyl (co)polymers are prepared by radical polymerisation, for example by emulsion, suspension, solution or mass polymerisation, preferably by emulsion or mass polymerisation, particularly preferably by emulsion polymerisation.

Particularly suitable rubber-modified vinyl (co)polymers are also ABS polymers which are prepared by the emulsion polymerisation process by redox initiation with an initiator system of organic hydroperoxide and ascorbic acid according to U.S. Pat. No. 4,937,285.

Rubber-free blend partners can also be used. Rubber-free vinyl (co)polymers which can be used are, for example and preferably, homo- and/or co-polymers of at least one monomer from the group of the vinyl aromatic compounds, vinyl cyanides (unsaturated nitriles), (meth)acrylic acid (C₁-C₈)-alkyl esters, unsaturated carboxylic acids and derivatives (such as anhydrides and imides) of unsaturated carboxylic acids.

Particularly suitable are (co)polymers of
from 50 to 99 parts by weight, preferably from 60 to 80 parts by weight, in particular from 70 to 80 parts by weight, in each case based on the (co)polymer, of at least one monomer selected from the group of the vinyl aromatic compounds (such as, for example, styrene,-methylstyrene), vinyl aromatic compounds substituted on the ring (such as, for example, p-methylstyrene, p-chlorostyrene) and (meth)acrylic acid (C₁-C₈)-alkyl esters (such as, for example, methyl methacrylate, n-butyl acrylate, tert-butyl acrylate) and
from 1 to 50 parts by weight, preferably from 20 to 40 parts by weight, in particular from 20 to 30 parts by weight, in each case based on the (co)polymer, of at least one monomer selected from the group of the vinyl cyanides (such as, for example, unsaturated nitriles such as acrylonitrile and methacrylonitrile), (meth)acrylic acid (C₁-C₈)-alkyl esters (such as, for example, methyl methacrylate, n-butyl acrylate, tert-butyl acrylate), unsaturated carboxylic acids and derivatives of unsaturated carboxylic acids (for example maleic anhydride and N-phenyl-maleimide).

The copolymer of styrene and acrylonitrile is particularly preferred.

Such vinyl (co)polymers are known and can be prepared by radical polymerisation, in particular by emulsion, suspension, solution or mass polymerisation.

In an embodiment that is particularly preferred according to the invention, the vinyl (co)polymers have a weight-average molar mass Mw (determined by gel chromatography in dichloromethane with polystyrene calibration) of from 50,000 to 250,000 g/mol, particularly preferably from 70,000 to 180,000 g/mol.

It must be possible to process the composition at the temperatures conventional for thermoplastics, that is to say at temperatures above 300° C., such as, for example, 350° C., without the optical properties, such as, for example, the deep gloss, or the mechanical properties changing significantly during the processing.

The preparation of the polymer composition for the base layer according to the invention comprising the components mentioned above takes place by conventional methods of incorporation by combination, mixing and homogenisation, the homogenisation in particular preferably being carried out in the melt under the action of shear forces. To that end, polycarbonate and optionally further components of the polymer, preferably the polycarbonate, moulding composition are preferably intimately mixed, extruded and granulated in the melt, under conventional conditions, in conventional melting/mixing units such as, for example, in single- or multi-shaft extruders or in kneaders. They can be metered either separately as granules or pellets by way of weigh feeders or side-feed devices or at elevated temperature as a melt by means of metering pumps into the solids feed region of the extruder at a suitable point or into the polymer melt. The masterbatches in the form of granules or pellets can also be combined with other particulate compounds to form a pre-mixture and then fed together via metering funnels or side-feed devices into the solids feed region of the extruder or into the polymer melt in the extruder. The compounding unit is preferably a twin-shaft extruder, particularly preferably a twin-shaft extruder having co-rotating shafts, the twin-shaft extruder having a length/diameter ratio of the screw shaft of preferably from 20 to 44, particularly preferably from 28 to 40. Such a twin-shaft extruder comprises a melting zone and a mixing zone or a combined melting and mixing zone (this “melting and mixing zone” is also referred to as a “kneading and melting zone” below) and optionally a degassing zone, in which an absolute pressure pabs of preferably not more than 800 mbar, more preferably not more than 500 mbar, particularly preferably not more than 200 mbar, is set. The mean residence time of the mixture composition in the extruder is preferably limited to not more than 120 seconds, particularly preferably not more than 80 seconds, most particularly preferably not more than 60 seconds. The temperature of the melt of the polymer, or of the polymer alloy, at the outlet of the extruder is from 200° C. to 400° C. in a preferred embodiment.

The process for the production of the multi-layer plastics mouldings that are stable to weathering comprises the steps of preparing a carbon-black-containing concentrate, preparing a compound comprising polycarbonate and the carbon-black-containing concentrate, producing a corresponding moulding, and coating the moulding in a one-stage, preferably a two-stage, coating process.

In a particular embodiment, the process for the production of multi-layer plastics mouldings that are stable to weathering and have a deep-gloss appearance comprises the following successive steps:

I. Preparation of a carbon black/PETS concentrate (component A)

Suitable mixing units for the preparation of the carbon black/fatty acid ester concentrates (step 1 of the process according to the invention) are single- or multi-shaft extruders or kneaders, such as, for example, Buss co-kneaders or intimate mixers or shear rollers, and all mixing units with which there can be introduced into the mixture of fatty acid ester melt and carbon black a shear energy that is sufficiently high to divide any solid carbon black agglomerates sufficiently finely and accordingly distribute the carbon black evenly in the fatty acid ester.

The starting components carbon black and fatty acid ester are fed to the compounding unit either separately or in the form of a powder or grain or granule mixture and mixed intimately in the melt at a heating temperature of the case of from 25° C. to 200° C., preferably from 30° C. to 130° C.

The concentrates so obtained preferably have a solid consistency at room temperature, depending on their carbon black content and the fatty acid ester used. The carbon black masterbatches are shaped into melt strands for metering in solid form, optionally filtered in the melt through a fine-mesh screen (10 to 100 μm mesh size, preferably 20 to 50 μm) in order to retain incompletely divided carbon black agglomerates, and then cooled to temperatures below 40° C., preferably below 30° C., and subsequently granulated.

Suitable granulating devices for the preparation of sufficiently finely divided granules/pellets of the carbon black masterbatch, which can easily be metered in the subsequent compounding of the polycarbonate moulding compositions, are underwater or hot die face water ring granulators. The granules or pellets so obtained have a maximum length of preferably 8 mm, particularly preferably not more than 5 mm, and a minimal length of preferably 0.5 mm, particularly preferably not less than 1 mm, the length defining the axis in the direction of the greatest extent of a body.

In an alternative embodiment, the masterbatch is used in the form of a powder having a maximum diameter of less than 0.5 mm and not less than 0.1 mm.

The amount of carbon black in the concentrate can vary within relatively wide limits from 3 wt. % to 70 wt. %, based on the masterbatch. The carbon black content is preferably from 30 wt. % to 70 wt. %, more preferably from 35 wt. % to 65 wt. %, particularly preferably from 40 to 62 wt. %.

II. Preparation of a compound (component B) of component A and polycarbonate having an MVR of from 7 cm³/(10 min) to 25 cm³/(10 min), preferably from 9 to 21 cm³/(10 min), according to ISO 1133 (at 300° C. and 1.2 kg load) comprising heat stabiliser, particularly preferably triphenylphosphine, so that the composition comprises from 0.05 to 0.15 wt. %, preferably from 0.06 to 0.12 wt. %, carbon black and from 0.1 to 0.5 wt. %, particularly preferably from 0.2 to 0.45 wt. %, PETS.

III. Production of a moulding from component B of appropriate moulding geometry, preferably at a tool temperature of from 60 to 150° C.

IV. Coating of the moulding by the flooding method with a primer solution comprising

a.) organic binder material that permits adhesion promotion between PC and a polysiloxane-based lacquer,

b.) at least one UV absorber,

c.) solvent

Exposure of the component to the air for from 10 to 60 minutes at room temperature and curing for from 5 minutes to 60 minutes at from 100 to 135° C.

V. Coating of the moulding by the flooding method with a siloxane lacquer comprising

a.) organosilicon compounds of the formula RₙSiX₄₋ₙ (where n is from 1 to 4), wherein R represents aliphatic C1 to C10 radicals, preferably methyl, ethyl, propyl, isopropyl, butyl and isobutyl, as well as aryl radicals, preferably phenyl, and substituted aryl radicals, and X represents H, aliphatic C1 to C10 radicals, preferably methyl, ethyl, propyl, isopropyl, butyl and isobutyl, as well as aryl radicals, preferably phenyl, substituted aryl radicals, or represents OH, Cl, or partial condensation products thereof.

b.) inorganic finely divided compound, preferably SiO₂

c.) an alcohol-based solvent

d.) at least one UV absorber

Exposure of the component to the air for from 10 to 60 minutes at room temperature and curing for from 10 minutes to 120 minutes at from 100 to 140° C.

The moulding is preferably used as a surround in the automotive sector, for example as surround coverings for A-, B- or C-pillars or as U-shaped, O-shaped or rectangular enclosures for, for example, glass elements in the roof region. Decorative surrounds are also included. Intermediate members which optically join glass units are also meant, as are intermediate members between the A-pillar and the B-pillar. These mouldings are also suitable for multi-media casings, such as, for example, television frames.

In step III of the process, the compositions can be converted into the moulded bodies according to the invention by, for example, hot pressing, spinning, blow moulding, deep drawing, extrusion or injection moulding. Injection moulding or injection-compression moulding is preferred.

Injection moulding processes are known to the person skilled in the art and are described, for example, in “Handbuch Spritzgiessen”, Friedrich Johannaber/Walter Michaeli, Munich; Vienna: Hanser, 2001, ISBN 3-446-15632-1 or “Anleitung zum Bau von Spritzgiesswerkzeugen”, Menges/Michaeli/Mohren, Munich; Vienna: Hanser, 1999, ISBN 3-446-21258-2.

Injection moulding here includes all injection moulding processes including multi-component injection moulding and injection-compression moulding.

For the production of single- and multi-component plastics mouldings, the injection moulding and injection-compression moulding variants known in plastics processing are used. Conventional injection moulding processes without injection-compression technology are used in particular for the production of smaller injection-moulded parts in which short flow paths occur and it is possible to work with moderate injection pressures. In the conventional injection moulding process, the plastics mass is injected into a cavity formed between two closed moulding plates which are in a fixed position, where it solidifies.

Injection-compression moulding processes differ from conventional injection moulding processes in that the injection and/or solidification operation is carried out with the execution of a moulding plate movement. In the known injection-compression moulding process, the moulding plates are already open slightly before the injection operation in order to compensate for the shrinkage that occurs during subsequent solidification and reduce the necessary injection pressure. A pre-enlarged cavity is therefore already present at the beginning of the injection operation. Shearing edges of the tool ensure that the pre-enlarged cavity is still sufficiently tight even with the moulding plates slightly open. The plastics mass is injected into this pre-enlarged cavity and, during or after the injection, is compressed in the closing direction with the execution of a tool movement. In particular in the production of large and thin-walled mouldings with long flow paths, the more complex injection-compression moulding technique is preferred or optionally absolutely necessary. Only in that manner is a reduction in the injection pressures required in the case of large mouldings achieved. Furthermore, stresses or distortion in the injection-moulded part, which occur as a result of high injection pressures, can be avoided by injection-compression moulding. This is important in particular in the case of the production of optical plastics applications, such as, for example, glazing (windows) in motor vehicles, because increased demands are to be observed in terms of freedom from stresses in the case of optical plastics applications.

Apart from the preferred processes mentioned above, various methods are known for producing a scratch-resistant coating on plastics articles. For example, lacquers based on epoxy, acrylic, polysiloxane, colloidal silica gel or inorganic/organic materials (hybrid systems) can be used. Such systems can be applied, for example, by dipping processes, spin coating, spraying processes or flow coating. Curing can be carried out thermally or by means of UV radiation. Single- or multi-layer systems can be used. The scratch-resistant coating can be applied, for example, directly or after preparation of the substrate surface with a primer. A scratch-resistant coating can further be applied by plasma-assisted polymerisation processes, for example via an SiO₂ plasma. Anti-fog or anti-reflection coatings can likewise be produced by plasma processes. It is further possible to apply a scratch-resistant coating to the resulting moulded body by means of specific injection moulding processes, such as, for example, the back-injection of surface-treated films. Various additives, such as, for example, UV absorbers derived, for example, from triazoles or triazines, can be present in the scratch-resistant layer.

For polycarbonates, a primer comprising UV absorber is preferably used in order to improve the adhesion of the scratch-resistant lacquer. The primer can comprise further stabilisers such as, for example, HALS systems (stabilisers based on sterically hindered amines), adhesion promoters, flow improvers. The resin in question can be chosen from a large number of materials and is described, for example, in Ullmann's Encyclopedia of Industrial Chemistry, 5th Edition, Vol. A18, pp. 368-426, VCH, Weinheim 1991. Polyacrylates, polyurethanes, phenol-based, melamine-based, epoxy and alkyd systems, or mixtures of these systems, can be used. The resin is in most cases dissolved in suitable solvents—frequently in alcohols. Depending on the chosen resin, curing can take place at room temperature or at elevated temperatures. Temperatures of from 50° C. to 140° C. are preferably used—frequently after a large proportion of the solvent has briefly been removed at room temperature. Commercially available systems are, for example, SHP470, SHP470FT and SHP401 from Momentive Performance Materials. Such coatings are described, for example, in U.S. Pat. No. 6,350,512 B1, U.S. Pat. No. 5,869,185, EP 1308084, WO 2006/108520.

Scratch-resistant lacquers (hard-coat) are preferably composed of siloxanes and preferably comprise UV absorbers. They are preferably applied by dipping or flow processes. Curing takes place at temperatures of from 50° C. to 140° C. Commercially available systems are, for example, AS4000, SHC5020 and AS4700 from Momentive Performance Materials. Such systems are described, for example, in U.S. Pat. No. 5,041,313, DE 3121385, U.S. Pat. No. 5,391,795, WO 2008/109072. The synthesis of these materials is in most cases carried out by condensation of alkoxy- and/or alkylalkoxy-silanes with acid or base catalysis. Nanoparticles can optionally be incorporated. Preferred solvents are alcohols such as butanol, isopropanol, methanol, ethanol and mixtures thereof.

Instead of primer/scratch-resistant coating combinations it is possible to use one-component hybrid systems. These are described, for example, in EP0570165 or WO 2008/071363 or DE 2804283. Commercially available hybrid systems are obtainable, for example, from Momentive Performance Materials under the names PHC587, PHC 587C or UVHC 3000.

There is particularly preferably used as the primer an adhesion-promoting UV protection primer based on polymethyl methacrylate comprising 1-methoxy-2-propanol and diacetone alcohol as solvent and a UV absorber combination comprising dibenzoylresorcinol and a triazine derivative. The topcoat is particularly preferably a polysiloxane topcoat of a sol-gel condensation product of methyltrimethylsilane with silica sol containing a silylated UV absorber.

In a particularly preferred process, application of the lacquer takes place by the flooding method, because it results in coated parts of high optical quality.

The flooding method can be carried out manually using a hose or suitable coating head or automatically in a continuous process using flood-coating robot and optionally sheet dies. The components can be coated either suspended or mounted in an appropriate product carrier.

In the case of larger and/or 3D components, the part to be coated is suspended or placed in a suitable product carrier.

In the case of small parts, coating can be carried out by hand. The liquid primer or lacquer solution to be applied is hereby poured over the sheet in the longitudinal direction starting from the upper edge of the small part, while the starting point of the lacquer on the sheet is at the same time guided from left to right over the width of the sheet. The lacquered sheets are exposed to the air and cured according to the manufacturer's instructions while being suspended vertically from a clamp.

The multi-layer bodies according to the invention can particularly preferably be used as frames for window modules for cars, railway vehicles and aircraft. Other frame parts are also preferred.

Within the context of the present invention, the UV range (ultraviolet) covers the wavelength range from 200 to 400 nm, the visual (visible) range covers the wavelength range from 400 to 780 nm, and the IR range (infra-red) covers the wavelength range from 780 to 1400 nm.

Within the meaning of the present invention, transparency means that the background can clearly be seen on looking through the transparent material, for example in the form of a corresponding moulded body. Mere light transmissibility, as in the case of frosted glass, for example, through which the background appears only indistinctly, is not sufficient for the corresponding material to be described as transparent. Transparent thermoplastic polymers, or the thermoplastic polymer compositions within the meaning of the present invention, also have an initial haze before weathering of less than 5.0%, preferably 4.0%, more preferably less than 3.0%, particularly preferably less than 2.0% (measured according to the present examples).

### EXAMPLES

The invention is described in greater detail below with reference to exemplary embodiments, the determination methods described herein being used for all corresponding parameters in the present invention unless indicated otherwise.

Melt Volume-Flow Rate:

The melt volume-flow rate (MVR) is determined according to ISO 1133 (at 300° C.; 1.2 kg).

Light Transmission (Ty):

The transmission measurements were carried out on a Lambda 900 spectral photometer from Perkin Elmer with a photometer cone according to ISO 13468-2 (i.e. determination of the total transmission by measuring the diffuse transmission and direct transmission).

Measurement and Evaluation of the Surface Faults:

The sample sheets are read out with a light microscope of the Axioplan2 type from Zeiss with a 2.5×/0.075 Epiplan Neofluar objective with an effective resolution of 3.97 μm/pixel on an adapted computer-controlled xy table. A region of 4×4 cm is thereby evaluated. The image processing software used is KS300 Version 3.0 from Zeiss. The sample surface is observed in incident light through a blue filter. Detection of the surface faults, which appear blue, is carried out in the HLS colour system with a scale of from 0 to 255 for the H (hue), L (lightness) and S (saturation) values; the HLS threshold values for detection of the surface faults are so adjusted that the blue colour thereof (H=127) is detected with L values greater than 157 and S values greater than 107. Adjustment of the L and S values is made in the respective histogram representations. Surface faults >10 μm are evaluated as defects.

3 sample sheets are measured in each case, and the corresponding mean value of the 3 sheets is valued as the average surface defect rate. The measurement is carried out on an uncoated sample sheet.

Visual Colour Impression/Deep-Gloss Effect:

Determination of the colour impression/deep-gloss effect is carried out visually by means of lacquered sample sheets (see production of the test specimens). To that end, the sample sheets are observed in daylight against a white background and classified accordingly (for classification see table test specimens and measurement results).

Black Impression:

The black impression is regarded as sufficient when, upon visual matching, the sample appears black, without the background being visible and the transmission at 780 nm on a 2 mm thick sample sheet being less than 0.01% (for measurement of transmission see above).

Materials for the production of the test specimens:
Linear bisphenol A polycarbonate having end groups based on phenol with an MVR of 12.5 cm³/10 min, measured at 300° C. and 1.2 kg load according to ISO 1133, comprising 250 ppm of triphenylphosphine (CAS 603-35-0), referred to as PC 1 hereinbelow
Demoulding agent: pentaerythritol tetrastearate (CAS 115-83-3), also referred to as PETS-1 below
Carbon black/pentaerythritol tetrastearate masterbatch comprising 58% carbon black (referred to as PETS-2 hereinbelow)
Black Pearls® 800 (CAS No. 1333-86-4) (particle size about 17 nm) from Cabot Corp. are used as the nanoscale carbon black.

Preparation of carbon black/PETS concentrate PETS 2:

An MDK/E 46 type co-kneader from Buss was used. 42 wt. % pentaerythritol tetrastearate and 58 wt. % nanoscale carbon black were metered in, and the demoulding agent was melted in the Buss kneader and mixed intimately with the carbon black. The melt strands leaving the die plate were then granulated by means of a hot die face water ring granulator known to the person skilled in the art to form granules having a length of up to 5 mm and cooled. The water adhering to the granules was then removed by means of a vibro screen and subsequent drying in a fluidised bed drier.

Preparation of the Thermoplastic Polymer Compositions by Compounding:

Compounding of the polymer composition was carried out on a twin-shaft extruder from KraussMaffei Berstorff, type ZE25, at a case temperature of 260° C., or a melt temperature of 270° C., and a speed of 100 rpm, with a throughput of 10 kg/h, using the amounts of components indicated in the examples.

Production of the Test Specimens:

The granules are dried for 3 hours at 120° C. in vacuo and then processed on an Arburg 370 injection-moulding machine having a 25-injection unit at a melt temperature of 300° C. and a tool temperature of 90° C. to form optical round sheets having a diameter of 80 mm and a thickness of 2.0 mm

Lacquering of the Test Specimens:

The product SHP470FT (Momentive Performance Materials Inc. Wilton, Conn. USA) is used as the primer. The product AS 4700 (Momentive Performance Materials Inc. Wilton, Conn. USA) is used as the protective lacquer.

Coating was carried out in a climate-controlled coating chamber as specified by the manufacturer in question at from 23 to 25° C. and from 40 to 48% relative humidity.

The test specimens were cleaned using so-called Iso cloths (LymSat® from LymTech Scientific; saturated with 70% isopropanol and 30% deionised water), rinsed with isopropanol, dried in the air for 30 minutes and blown with ionised air.

Coating of the test specimens is carried out by hand by the flooding method. The primer solution is poured over the sheet in the longitudinal direction starting from the upper edge of the small part, while the starting point of the primer on the sheet is at the same time guided from left to right over the width of the sheet. The primed sheet was exposed to the air until dust-dry as specified by the respective manufacturer while being suspended vertically from a clamp and was cured in a circulating-air oven (exposed to the air for 30 minutes at room temperature and cured for 30 minutes at 125° C.). After cooling to room temperature, coating of the primed surface with AS 4700 was carried out. After being exposed to the air until dust-dry, curing was carried out for 60 minutes at 130° C. in a circulating-air oven.

The thickness of the primer layer and the thickness of the topcoat can affect the weathering properties.

In order to achieve a sufficient and comparable protective action against weathering, the primer layer thickness for the following examples should be in the range from 1.2 to 4.0 μm and the thickness of the topcoat should be from 4.0 to 8.0 μm.

### Example 1

### Comparison Example

A polymer composition comprising the amounts of the following components is prepared by compounding as described above. Carbon black and demoulding agent are not pre-mixed (use of PETS-1).

| | |
|---|---|
| BlackPearls 800 | 0.16 wt. % |
| (CAS No. 1333-86-4) | |
| PETS | 0.4 wt. % |
| PC1: | 99.44 wt. % |

TABLE 1
Microscan result; uncoated sample sheet

| | Defects/cm² |
|---|---|
| Sheet 1 | 98 |
| Sheet 2 | 90 |
| Sheet 3 | 86 |
| Ø | 91 |

The sample sheet is coated as described above and the optical properties are evaluated. The results are summarised in Table 6.

### Example 2

### Comparison Example

A polymer composition comprising the amounts of the following components is prepared as described above. A carbon black/PETS pre-mixture is used (PETS-2).

| | |
|---|---|
| BlackPearls 800: | 0.16 wt. % |
| PETS: | 0.40 wt. % |
| PC1: | 90.44 wt. % |

TABLE 2
Microscan result; uncoated sample
sheet (80.0 × 2.0 mm round sheet)

| | Defects/cm² |
|---|---|
| Sheet 1 | 30 |
| Sheet 2 | 8 |
| Sheet 3 | 11 |
| Ø | 16 |

The sample sheet is coated as described above and the optical properties are evaluated. The results are summarised in Table 6.

### Example 3

### According to the Invention

A polymer composition comprising the amounts of the following components is prepared by compounding as described above. Carbon black and demoulding agent are not pre-mixed (use of PETS-1).

| | |
|---|---|
| BlackPearls 800: | 0.08 wt. % |
| PETS-1: | 0.40 wt. % |
| PC1: | 99.52 wt. % |

TABLE 3
Microscan result; uncoated sample
sheet (80.0 × 2.0 mm round sheet)

| | Defects/cm² |
|---|---|
| Sheet 1 | 9 |
| Sheet 2 | 6 |
| Sheet 3 | 7 |
| Ø | 8 |

The sample sheet is coated as described above and the optical properties are evaluated. The results are summarised in Table 6.

### Example 4

### Comparison Example

A polymer composition comprising the amounts of the following components is prepared as described above. Carbon black and demoulding agent are not pre-mixed (use of PETS 1).

| | |
|---|---|
| BlackPearls 800: | 0.04 wt. % |
| PETS-1 | 0.4 wt. % |
| PC1: | 99.56 wt. % |

TABLE 4
Microscan result; uncoated sample
sheet (80.0 × 2.0 mm round sheet)

| | Defects/cm² |
|---|---|
| Sheet 1 | 10 |
| Sheet 2 | 8 |
| Sheet 3 | 7 |
| Ø | 8 |

The sample sheet is coated as described above and the optical properties are evaluated. The results are summarised in Table 6.

### Example 5

### According to the Invention

A polymer composition comprising the amounts of the following compounds is prepared as described above; a carbon black/PETS pre-mixture is used (PETS-2).

| | |
|---|---|
| BlackPearls 800: | 0.08 wt. % |
| PETS-2: | 0.40 wt. % |
| PC1: | 99.52 wt. % |

TABLE 5
Microscan result; uncoated sample
sheet (80.0 × 2.0 mm round sheet)

| | Defects/cm² |
|---|---|
| Sheet 1 | 3 |
| Sheet 2 | 2 |
| Sheet 3 | 4 |
| Ø | 3 |

The sample sheet is coated as described above and the optical properties are evaluated. The results are summarised in Table 6.

TABLE 6
Visual matching of the lacquered test
specimens (80.0 × 2.0 mm round sheet)

| | Surface quality | Deep- | Trans- | |
|---|---|---|---|---|
| | Visual | gloss | mission | Black |
| Example | matching | effect | at 780 nm | impression |
| 1 (comparison) | −− | −− | <0.01% | + |
| 2 (comparison) | ◯ | − | <0.01% | + |
| 3 (invention) | + | ◯ | <0.01% | + |
| 4 (comparison) | + | − | 0.08% | − |
| 5 (invention) | + | + | <0.01% | + |

Evaluation: + pleasing; ◯ satisfactory; − poor; −− very poor

Overall, only the multi-layer bodies according to the invention have the required property combination of high deep gloss, low to no transmission even at 780 nm, and high surface quality.

The comparison examples show that only very specific combinations are expedient. This was surprising and could not be deduced from the prior art. Thus, for example, the multi-layer body having a carbon black amount of 0.04% surprisingly does not exhibit fewer defects than a sample with 0.08%, but the transmission increases significantly.

1.-14. (canceled)

15. A multi-layer body comprising:
1) a base layer comprising
at least one thermoplastic,
nanoscale carbon black in an amount of from 0.05 to 0.15 wt. %,
a demoulding agent based on a fatty acid ester in a concentration of from 0.1 to 0.5 wt. %,
2) at least on one side of the base layer, a scratch-resistant coating based on polysiloxane, having a thickness of from 2 to 15 μm, comprising at least one UV absorber.
wherein the sum of the values of the above-mentioned components of the base layer does not exceed 100 wt. %.

16. The multi-layer body according to claim 15, wherein the multi-layer body has on the side of the scratch-resistant coating a surface defect rate of less than 10 surface defects per cm².

17. The multi-layer body according to claim 15, wherein there is additionally arranged on the base layer, between the base layer and the scratch-resistant layer, an adhesion-promoting layer having a thickness of from 0.3 to 8 μm, comprising at least one UV absorber.

18. The multi-layer body according to claim 15, wherein the thermoplastic is selected from the group comprising polycarbonate and polycarbonate blends having a melt volume-flow rate of from 7 cm³/(10 min) to 25 cm³/(10 min).

19. The multi-layer body according to claim 15, wherein the demoulding agent and the carbon black are introduced as a masterbatch of carbon black in the demoulding agent.

20. The multi-layer body according to claim 15, wherein the demoulding agent is pentaerythritol tetrastearate.

21. The multi-layer body according to claim 15, wherein the base layer comprises a heat stabilizer.

22. The multi-layer body according to claim 15, wherein a scratch-resistant layer and optionally an adhesion-promoting layer are arranged on both sides of the base layer.

23. The multi-layer body according to claim 15, wherein the carbon black has a primary particle size of from 10 to 20 nm.

24. The multi-layer body according to claim 15, wherein the scratch-resistant layer is a polysiloxane lacquer.

25. A process for the production of a multi-layer body having a deep-gloss appearance, comprising the steps:
preparing a carbon-black-containing masterbatch with demoulding agent,
preparing a compound comprising polycarbonate and the carbon-black-containing masterbatch, wherein the carbon black is in an amount of from 0.05 to 0.15 wt. %, and the demoulding agent is in a concentration of from 0.1 to 0.5 wt. %,
producing a moulding,
coating of the moulding with a scratch-resistant layer in a one-stage coating process.

26. The process according to claim 25, wherein a primer layer is applied before the moulding is coated with the scratch-resistant layer.

27. The process according to claim 25, wherein the steps are carried out in the sequence given.

28. An automotive exterior part, an automotive interior part or a frame part for glazing of glass or polycarbonate which comprises the multi-layer body as claimed in claim 15.
